(19) United States
(12) Patent Application Publication
(10) Pub. No.: US 2012/0074339 A1
(43) Pub. Date: Mar. 29, 2012

(54) REGULATING VALVE DEVICE

(75) Inventors: Nobukazu Ikeda, Osaka (JP); Michio Yamaji, Osaka (JP); Tsuyoshi Tanigawa, Osaka (JP); Hiroshi Kaneko, Miyagi (JP); Yasushi Yagi, Miyagi (JP); Yuji Ono, Miyagi (JP); Tadahiro Ohmi, Miyagi (JP); Yasuyuki Shirai, Miyagi (JP)

(73) Assignees: Fujikin Incorporated, Osaka (JP); Tohoku University, Miyagi (JP); Tokyo Electron Limited, Miyagi (JP)

(21) Appl. No.: 13/138,670

(22) PCT Filed: Mar. 8, 2010
(86) PCT No.: PCT/JP2010/053749

§ 371 Date: Nov. 29, 2011

(30) Foreign Application Priority Data
Mar. 17, 2009 (JP) 2009-064546

(51) Int. Cl. F16K 31/12

(52) U.S. Cl. 251/12

(57) ABSTRACT

[Problem] To provide a regulating valve device having a valve element opened or closed by a working fluid.

[Solution to Problem] A valve element 310 has a structure in which a valve head 310a and a valve body 310b are coupled by a valve stem 310c. In the valve box 305, the valve element 310 and a power transmitting member 320a are slidably housed. A first bellows 320b is fixed to the power transmitting member 320a and the valve box 305 to form a first space Us at a position on a side of the power transmitting member 320a opposite the valve element. A second bellows 320c is fixed to the power transmitting member 320a and the valve box 305 to form a second space Ls at a position on a side of the power transmitting member 320a closer to the valve element. According to a ratio of air supplied to the first space Us from a first pipe 320d and air supplied to the second space Ls from a second pipe 320e, the power transmitting member 320a transmits power to the valve head 310a to open or close a transport channel 200a.

### TECHNICAL FIELD

The present invention relates to a regulating valve device having a valve element opened or closed by a working fluid such as air.

### BACKGROUND ART

In a semiconductor manufacturing and other manufacturing apparatuses for manufacturing an organic EL (Electro Luminescence) devices, FPD (Flat Panel Display) devices, or the like, in order to open or close a transport channel of a fluid used for the manufacture such as film formation and to adjust a flow rate, it has been conventionally proposed to provide a regulating valve device in the transport channel (refer to Patent Documents 1, 2). For example, in valve regulating devices described in Patent Documents 1 and 2, one end of a bellows is welded to a valve element and its other end is welded to a bellows holder, whereby a transport channel and a space around the valve stem in a valve box housing the valve element are separated by the bellows. The valve element is slid in this state to abut on a valve seat surface of the transport channel or to separate from the valve seat surface, whereby the transport channel is opened or closed and the flow rate is adjusted. The valve element and the valve seat surface are made of, for example, stainless steel such as SUS or aluminum.

### PRIOR ART DOCUMENTS

### Patent Documents

Patent Document 1: Japanese Patent Application Laid-open No. Hei 06-074363
Patent Document 2: Japanese Patent Application Laid-open No. Hei 11-153235

### SUMMARY OF THE INVENTION

### Problem to be Solved by the Invention

However, at the time of an opening/closing operation of the valve element, leakage sometimes occurs in an opening/closing portion of the valve element, due to mechanical interference between the valve element and the valve seat surface and a slight deviation between the valve element and the valve seat surface occurring at the assembly time. Especially when the opening/closing operation of the valve element is performed under a process condition where temperature of the inside of the regulating valve device reaches 300° C. or higher, the occurrence frequency of the leakage becomes higher and a leakage amount becomes large. For example, let us think of a case where the regulating valve device is attached to a transport channel of an organic EL apparatus and the transport channel is opened or closed by the regulating valve device. A film forming material (organic molecules) evaporated in a vapor deposition source passes through the transport channel with carrier gas to be carried to a substrate. During the transport, in order to avoid the adhesion of the film forming material on an inner wall of the transport channel, it is necessary to set the transport channel to a high-temperature state of 300° C. or higher in consideration of an attachment coefficient. Accordingly, the vicinity of the valve element comes into the high temperature state of 300° C. or higher. When the opening/closing operation of the valve element is repeated in this state, friction and melting occur between the valve element and the valve seat surface not only due to the mechanical interference but also due to an influence of heat, which causes galling and seizing. This as a result causes the frequent occurrence of leakage in the opening/closing portion of the valve element and also increases a leakage amount. In a valve element coated with resin such as Ni—Co, a possibility of the occurrence of galling and seizing increases because the resin deforms and melts when exposed to high temperature due to its low heat proof temperature. This as a result further increases the occurrence frequency of the leakage to lower opening/closing accuracy of the valve element.

Therefore, in order to solve the aforesaid problem, it is an object of the present invention to provide a regulating valve device in which the structure and shape of a valve element are optimized and opening/closing accuracy of the valve element is improved.

### Solution to Problem

Specifically, in order to solve the aforesaid problem, there is provided a regulating valve device including: a valve element in which a valve head and a valve body are coupled by a valve stem; a power transmitting member coupled to the valve element via the valve stem and transmitting power to the valve element; a valve box in which the valve element and the power transmitting member are slidably housed; a first bellows having one end fixed to the power transmitting member and the other end fixed to the valve box to form a first space at a position on a side of the power transmitting member opposite the valve element; a second bellows having one end fixed to the power transmitting member and the other end fixed to the valve box to form a second space at a position on a side of the power transmitting member closer to the valve element; a first pipe communicating with the first space; and a second pipe communicating with the second space, wherein, according to a ratio of a working fluid supplied to the first space from the first pipe and a working fluid supplied to the second space from the second pipe, the power transmitting member transmits the power to the valve element via the valve stem to cause the valve head to open or close a transport channel formed in the valve box.

According to the above, as shown in FIG. 5, a first space Us is formed at a position on a side of a power transmitting member 320a opposite a valve element 310 by using a first bellows 320b, and a second space Ls is formed at a position on a side of the power transmitting member 320a closer to the valve element, by using the first bellows 320b and a second bellows 320c. It is possible to slide the power transmitting member 320a sandwiched by the first and second spaces in a closing direction or an opening direction of the valve element, according to a ratio of a working fluid supplied to the first space Us and a working fluid supplied to the second space Ls. The power is transmitted to a valve head 310a via a valve stem 310c. As a result, a transport channel (an outward route 200a1 and a return route 200a2) can be opened or closed by the valve head 310a.

The valve element may have a structure in which the valve head and the valve body are coupled by the valve stem, or may have a structure in which the valve head and the valve body are integrated.

Further, the valve stem may penetrate through a longitudinal center of the valve body to be inserted to a concave portion provided at a center of the valve head.

Further, an allowance may be provided between the concave portion provided at the center of the valve head and the valve stem.

With this structure, it is possible to correct displacement of the valve stem 310c by controlling a clearance between the valve body 310b and the valve stem 310c in FIG. 5, and providing an allowance 310a2 in a concave portion 310a1 of the valve head 310a makes it possible to adjust a small deviation of an axis of the valve head 310a. Consequently, by making the valve head 310a abut on a valve seat surface 200a3 without any deviation, it is possible to bring the valve head 310a and the valve seat surface 200a3 into closer contact with each other, resulting in prevention of leakage.

A space on the valve stem side and a space on the transport channel side may be shut off from each other by fixing one end to the valve head and fixing the other end to the valve body.

A portion, of the valve head, abutting on the transport channel may be tapered and a divergence θ of taper with respect to a line perpendicular to an end surface of the valve head may be 40° to 80°.

A portion, of the valve head, abutting on the transport channel may be arc-shaped and may have a structure having a desired radius of curvature.

The valve head may be metal overlaid with Stellite to have a 500 HV Vickers hardness or higher.

The valve head may be overlaid with a cobalt alloy-based material by welding.

A valve seat surface of the transport channel abutting on the valve head may be metal whose surface is worked by sheet burnishing to have Vickers hardness of approximately not less than 200 nor more than 400 HV.

The regulating valve device is used for opening/closing a transport channel transporting an organic molecule for film formation on an object to be processed, up to a vicinity of the object to be processed.

The regulating valve device is used under an environment where an inner part of the regulating valve device becomes 300° C. or higher.

### Effect of the Invention

As described above, according to the present invention, it is possible to optimize the structure and shape of a valve element to improve opening/closing accuracy of the valve element.

### BRIEF DESCRIPTION OF THE DRAWINGS

FIG. 1 is a schematic perspective view of a six-layer continuous film forming apparatus according to an embodiment of the present invention;

FIG. 2 is a cross-sectional view of a film forming unit according to the embodiment;

FIG. 3 is a schematic view of an organic EL element formed by the six-layer continuous film forming apparatus according to the embodiment;

FIG. 4 is a cross-sectional view of a vapor deposition source and a transport channel according to the embodiment;

FIG. 5 is a cross-sectional view of a regulating valve device according to the embodiment; and

FIG. 6 is a chart showing results of the detection of a leakage amount when the regulating valve device according to the embodiment is used.

### MODE FOR CARRYING OUT THE INVENTION

Hereinafter, a regulating valve device according to an embodiment of the present invention will be described in detail with reference to the attached drawings. Note that in the following description and the attached drawings, constituent elements having the same structure and function are denoted by the same reference numerals and symbols and redundant description thereof will be omitted.

The description below proceeds in the following order.

1. whole structure of a six-layer continuous film forming apparatus using the regulating valve device

2. inner structure of a film forming unit of the six-layer continuous film forming apparatus

3. inner structure of the regulating valve device of the film forming unit

4. structures, shapes, and surface treatments of a valve element and a valve seat surface

5. verification of leakage state

[Six-Layer Continuous Film Forming Apparatus]

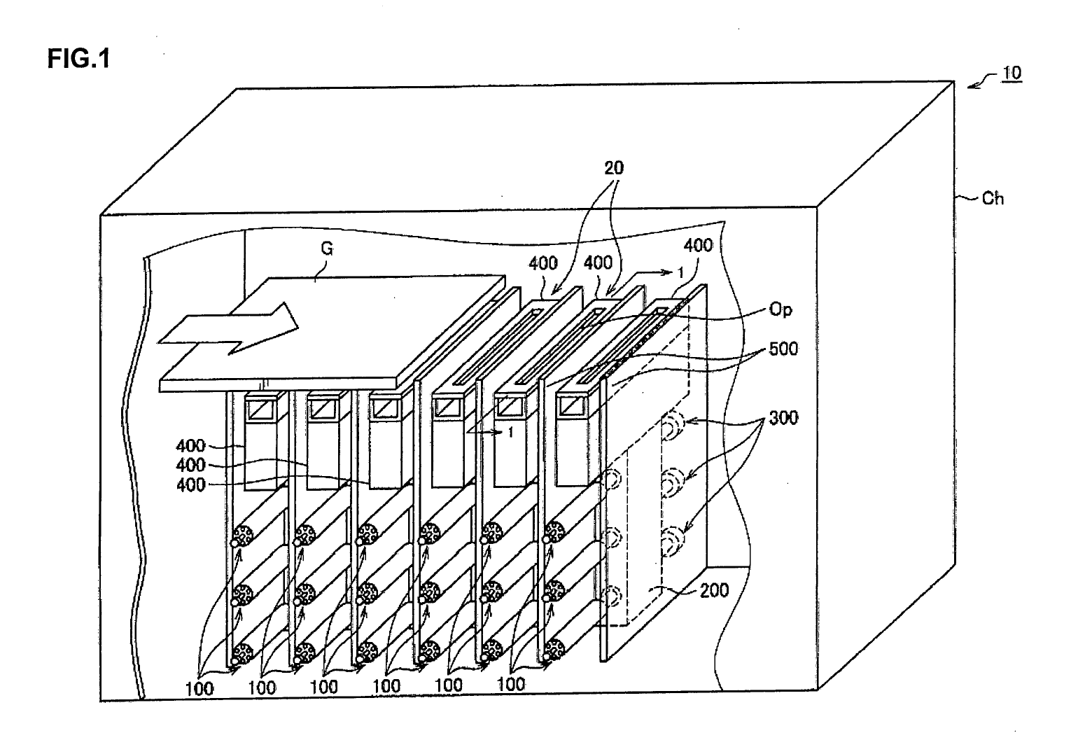

First, the six-layer continuous film forming apparatus using the regulating valve device according to the embodiment of the present invention will be described with reference to FIG. 1 showing its schematic structure.

The six-layer continuous film forming apparatus 10 has a rectangular vacuum vessel Ch. The inside of the vacuum vessel Ch is exhausted by a not-shown exhaust device and is kept in a desired vacuum state. In the vacuum vessel Ch, six film forming units 20 are arranged side by side. In each space between the adjacent film forming units 20, a partition plate 500 is provided. The film forming units 20 each have three vapor deposition source units 100 in a rectangular shape, a coupling pipe 200, three regulating valve devices 300 each making a pair with the vapor deposition source unit 100, and a blowout mechanism 400.

The vapor deposition source units 100 are made of metal such as SUS. Since quartz or the like is difficult to react with an organic material, the vapor deposition source units 100 may be made of metal coated with quartz or the like. It should be noted that the vapor deposition source unit 100 is only an example of a vapor deposition source vaporizing the material, and need not be a unit-type vapor deposition source and may be an ordinary pot.

In the vapor deposition source units 100, organic materials of different kinds are contained. In a wall surface of each of the vapor deposition source units 100, a not-shown heater is buried. The heaters each warm the vapor deposition source unit 100 to a desired temperature to vaporize the organic material. Note that “vaporization” includes not only a phenomenon that liquid changes to gas but also a phenomenon that a solid changes directly to gas without becoming liquid (that is, sublimation).

Vaporized organic molecules pass through the coupling pipe 200 to be carried to the blowout mechanism 400 and are blown out from openings Op in a slit shape provided in an upper portion of the blowout mechanism 400. The blown organic molecules are attached to a substrate G, so that the substrate G undergoes film formation. The partition plates 500 each prevent films from being formed while the organic molecules blown out from the adjacent openings Op are mixed. Incidentally, in this embodiment, the face-down substrate G sliding and moving at a ceiling position of the vacuum vessel Ch undergoes the film formation as shown in FIG. 1, but the substrate G may be set face-up.

[Film Forming Unit]

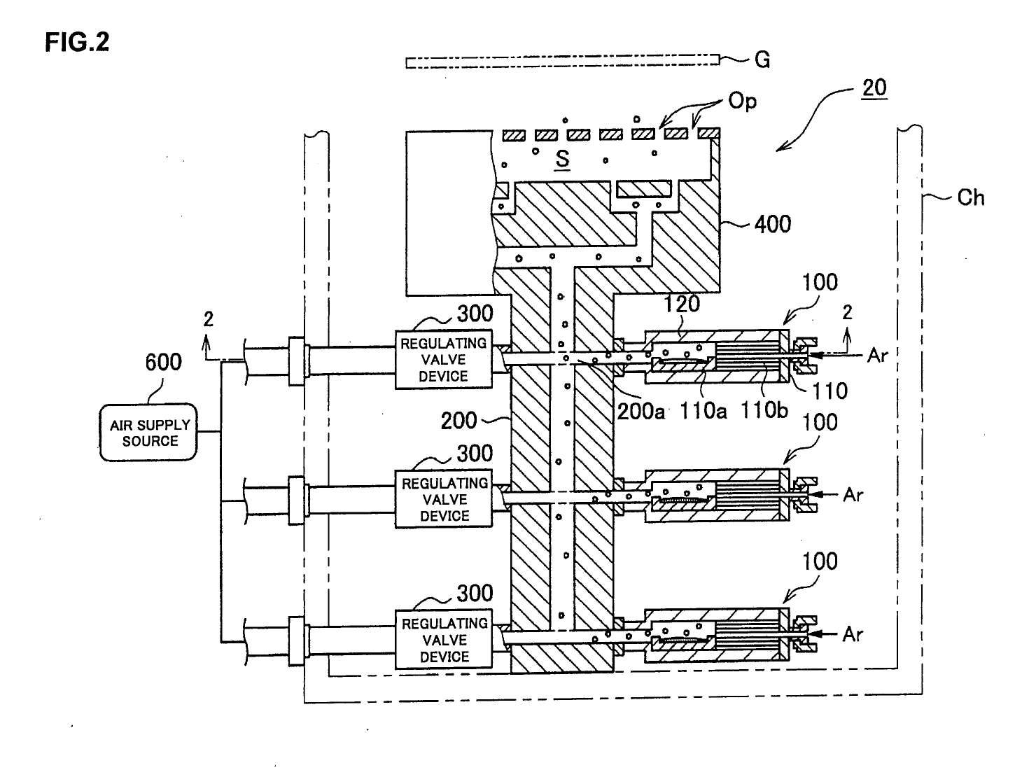

Next, the inner structure of the film forming unit 20 will be described with reference to FIG. 2 showing a 1-1 cross section in FIG. 1. The other five film forming units 20 shown in FIG. 1 have the same structure as that of the film forming unit 20 having the 1-1 cross section in FIG. 1, and therefore description thereof will be omitted.

The vapor deposition source units 100 each have a material charger 110 and an outer case 120. The material charger 110 has a material container 110a housing the organic film forming material and an inlet channel 110b for carrier gas. The outer case 120 is formed in a bottle shape, and in its hollow inside, the material charger 110 is attachably/detachably mounted. When the material charger 110 is mounted in the outer case 120, an inner space of the vapor deposition source unit 100 is demarcated. The inner spaces of the vapor deposition source units 100 communicate with transport channels 200a formed in the coupling pipe 200. The transport channels 200a are opened or closed by opening/closing mechanisms of the regulating valve devices 300. The regulating valve devices 300 open or close the transport channels 200a by pressurized air supplied from an air supply source 600 provided outside the vacuum vessel Ch. The inner structure of the regulating valve device 300 will be described later.

End portions of the material chargers 110 are connected to a not-shown gas supply source and let argon gas supplied from the gas supply source into the channels 110b. The argon gas functions as the carrier gas carrying the organic molecules being the film forming materials housed in the material containers 110a. It should be noted that the carrier gas is not limited to argon gas but only need to be inert gas such as helium gas or krypton gas.

The organic molecules of the film forming materials are carried from the vapor deposition source units 100 to the blowout mechanism 400 through the transport channels 200a of the coupling pipe 200, and after temporarily staying in a buffer space S, pass through the openings Op in the slit shape to adhere on the substrate G.

[Structure of Organic Film]

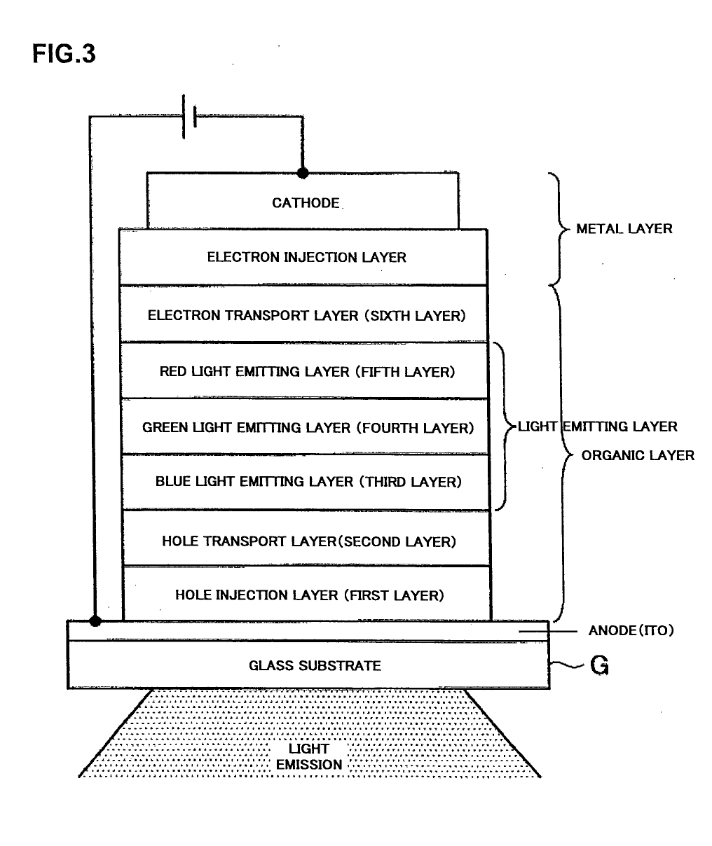

In the six-layer continuous film forming apparatus 10 according to this embodiment, the substrate G moves forward above the first to sixth blowout mechanisms 400 at a prescribed speed as shown in FIG. 1. While the substrate G moves forward, a hole injection layer being a first layer, a hole transport layer being a second layer, a blue light emitting layer being a third layer, a green light emitting layer being a fourth layer, a red light emitting layer being a fifth layer, and an electron transport layer being a sixth layer are formed in sequence on ITO of the substrate G, as shown in FIG. 3. In this manner, in the six-layer continuous film forming apparatus 10 according to this embodiment, the first to sixth organic layers are continuously formed. Among them, the blue light emitting layer, the green light emitting layer, and the red light emitting layer which are the third to fifth layers are light emitting layers emitting light through recombination of holes and electrons. Further, metal layers (the electron injection layer and a cathode) on the organic layers are formed by sputtering.

Consequently, an organic EL element in which the organic layers are sandwiched by an anode and the cathode is formed on the glass substrate. When voltage is applied to the anode and the cathode of the organic EL element, holes (positive holes) are injected to the organic layers from the anode, and the electrons are injected to the organic layers from the cathode. The injected holes and electrons recombine in the organic layers, and at this time, the light emission occurs.

[Routes of Transport Channel]

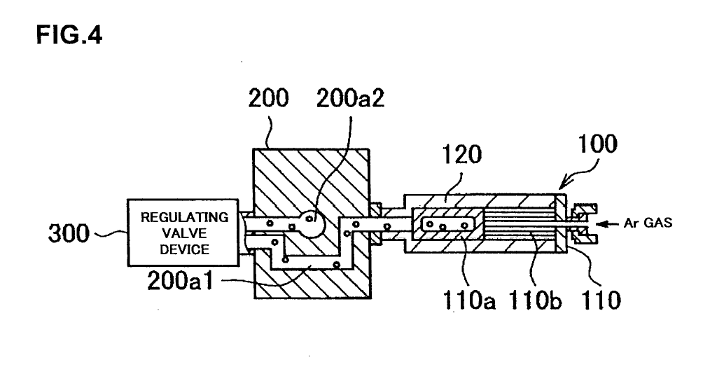

Next, routes of the transport channel 200a will be simply described with reference to FIG. 4 showing a 2-2 cross section in FIG. 2. As previously described, the coupling pipe 200 carries the vaporized organic molecules to the blowout mechanism 400 side via the regulating valve devices 300. Concretely, since the valve elements of the regulating valve devices 300 are opened during the film formation, the organic molecules vaporized in the vapor deposition source units 100 are led from outward routes 200a1 to return routes 200a2 of the transport channels to be carried to the blowout mechanism 400 while carried by the carrier gas. On the other hand, since the valve elements of the regulating valve devices 300 are closed while the film formation is not performed, the outward channels 200a1 and the return channels 200a2 of the transport channels are closed, and the transport of the organic molecules is stopped.

[Regulating Valve Device]

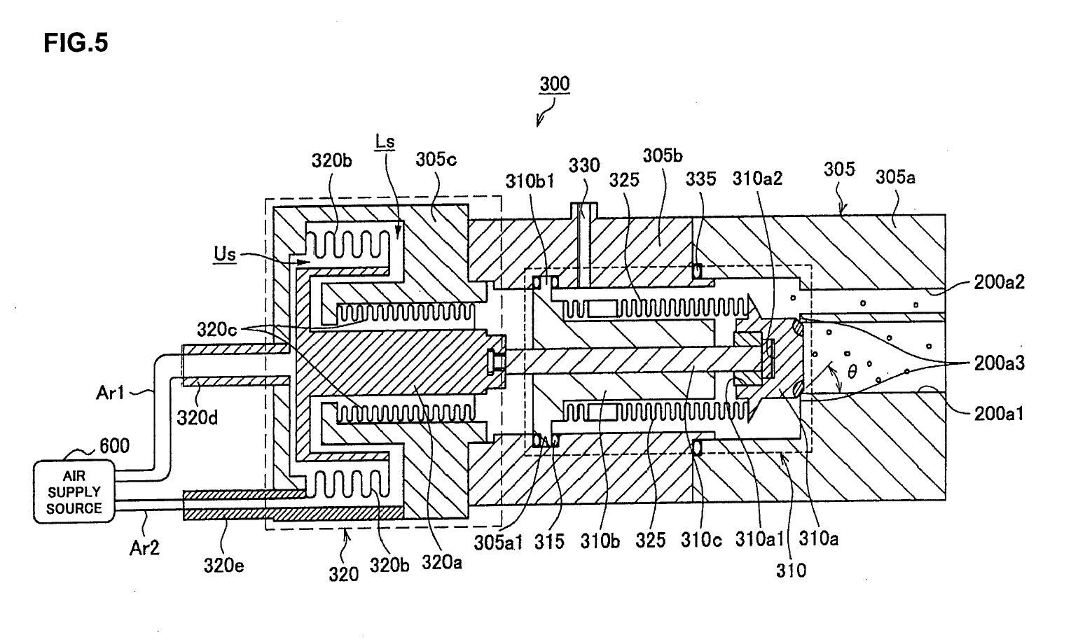

Next, the inner structure and operation of the regulating valve device 300 will be described in detail with reference to FIG. 5 showing a cross section of the regulating valve device 300. The regulating valve device 300 has a cylindrical valve box 305. The valve box 305 is divided into three parts, that is, a front member 305a, a center bonnet 305b, and a rear member 305c. The valve box 305 is hollow and the valve element 310 is disposed at a substantial center thereof.

The valve element 310 is separated into a valve head 310a and a valve body 310b. The valve head 310a and the valve body 310b are coupled by a valve stem 310c. Concretely, the valve stem 310c is a rod-shaped member, which penetrates through a longitudinal center of the valve body 310b and is fit in a concave portion 310a1 provided at a center of the valve head 310a. A projection 310b1 of the valve body 310b is inserted in an annular concave portion 305a1 provided in the bonnet 305b of the valve box 305. In the front member 305a of the valve box 305, the outward route 200a1 and the return route 200a2 of the transport channel 200a are formed.

In the concave portion 305a1, there is provided a space in which the valve body 310b is slidable in its longitudinal direction while the projection 310b1 is inserted therein. In this space, a heat-resistant buffer member 315 is provided. An example of the buffer member 315 is a metal gasket. The buffer member 315 shuts off the vacuum on the transport channel side and the atmosphere on the valve stem 310c side and also alleviates the mechanical interference between the projection 310b1 and the bonnet 305b ascribable to the sliding of the valve body 310b.

(Separation Structure of Valve Body and Valve Head)

An allowance 310a2 is also provided in the concave portion 310a1 of the valve head 310a in a state where the valve stem 310c is inserted thereto. In the valve element 310 according to this embodiment, since the valve body 310b and the valve head 310a are separated from each other, a deviation of a center position of the valve element 310 at the time of the opening/closing operation is corrected by controlling a clearance (gap) between the valve body 310b and the valve stem 310c. In addition, by providing the allowance 310a2 in the concave portion 310a1 of the valve head 310a, it is possible to adjust a small deviation of an axis of the valve head 310a. Consequently, by making the valve head 310a abut on the valve seat surface 200a3 without deviation, it is possible to bring the valve head 310a and the valve seat surface 200a3 into closer contact to prevent leakage. As a result, according to the separation-type valve element 310 according to this embodiment, even when the regulating valve device 300 is used in a high temperature state or is used in a low temperature state and accordingly an influence due to thermal expansion of metal occurs, the influence can be adsorbed owing to the separation structure of the valve element 310 as described above. Therefore, it is possible to effectively prevent the leakage in the valve element portion at the time of the opening/closing, compared with an integration-type valve element.

A valve driving part 320 is provided in the rear member 305c of the valve box 305. The valve driving part 320 also has the power transmitting member 320a, the first bellows 320b, and the second bellows 320c which are built in the valve box 305. The power transmitting member 320a is substantially in a T shape and is screwed to an end portion of the valve stem 310c.

The first bellows 320b has one end welded to the power transmitting member 320a and the other end welded to the rear member 305c. Consequently, at a position closer to a rear part of the valve box 305 (at a position on a side of the power transmitting member 320a opposite the valve element 310), there is formed a first space Us demarcated by the power transmitting member 320a, the first bellows 320b, and the rear member 305c.

The second bellows 320c has one end welded to the power transmitting member 320a and the other end welded to the rear member 305c. Consequently, at a position closer to a front part of the valve box 305 (at a position on a side of the power transmitting member 320a closer to the valve element), there is formed a second space Ls demarcated by the power transmitting member 320a, the first bellows 320b, the second bellows 320c, and the rear member 305c.

A first pipe 320d communicates with the first space Us demarcated by the first bellows 320b. The first pipe 320d is coupled to a supply pipe Ar1 of the air supply source 600. The first pipe 320d supplies the first space Us with the pressurized air output from the air supply source 600.

The second pipe 320e communicates with the second space Ls demarcated by the first bellows 320b and the second bellows 320c. The second pipe 320e is coupled to a supply pipe Ar2 of the air supply source 600. The second pipe 320e supplies the second space Ls with the pressurized air output from the air supply source 600.

With the above structure, according to a ratio of the pressurized air supplied from the first pipe 320d to the first space Us and the pressurized air supplied from the second pipe 320e to the second space Ls, the power transmitting member 320a transmits the power to the valve head 310a via the valve stem 310c. Consequently, the valve head 310a opens or closes the outward route 200a1 and the return route 200a2 of the transport channel formed in the valve box 305 by moving back and forth in its longitudinal direction. The opening/closing direction is determined by the ratio of the pressurized air supplied to the first space Us and the pressurized air supplied to the second space Ls.

For example, when a ratio of the pressurized air supplied to the first space Us to the pressurized air supplied to the second space Ls becomes high, the power transmitting member 320a slides in a direction in which it presses the valve element 310, the valve head 310a is pushed in a forward direction via the valve stem 310c, and consequently, the valve head 310a closes the outward route 200a1 of the transport channel and the valve element 310 is closed.

On the other hand, when the ratio of the pressurized air supplied to the first space Us to the pressurized air supplied to the second space Ls becomes low, the power transmitting member 320a slides in a direction in which it pulls the valve element 310, the valve head 310a is pulled in a backward direction via the valve stem 310c, and consequently, the valve head 310a separates from the outward route 200a1 of the transport channel and the valve element 310 is opened.

A third bellows 325 has one end welded to the valve head 310a and the other end welded to the valve body 310b. Consequently, an atmospheric space on the valve stem side and the vacuum space on the transport channel side are shut off from each other. Further, by the third bellows 325 supporting a gap between the valve body 310b and the valve head 310a, the clearance between the valve body 310b and the valve stem 310c can be controlled. Consequently, the control is performed so that friction does not occur due to the contact of the valve body 310b and the valve stem 310c at the time of the valve opening/closing operation. Incidentally, in the bonnet 305b, there is provided a purge port 330 purging an airtight space between the bonnet 305b and the valve driving part 320.

On a contact surface between the front member 305a and the bonnet 305b of the valve box 305 and a contact surface between the bonnet 305b and the rear member 305c, sealing metal gaskets 335 for ensuring sealability are interposed. This makes it possible for the regulating valve device 300 to have a structure suitable for use under the vacuum environment.

[Surface Treatments of Valve Element and Valve Seat Surface]

In the regulating valve device 300 according to this embodiment, in addition to that the valve element 310 is formed to have the separation structure as described above, materials, shapes, and surface workings of the valve element and the valve seat are optimized so that operability and sealability can be stably maintained even under the high-temperature environment of about 500° C.

(Materials and Surface Treatments of Valve Element and Valve Seat)

Concretely, the present inventors adopted austenitic stainless steel excellent in heat resistance as the material of the valve seat surface 200a3 and the valve element 310. In addition, the present inventors worked the surface of the valve element 310 by Stellite (registered trademark) finish or F2 coat (registered trademark) so that its Vickers hardness becomes 500 HV or higher. Stellite is stainless steel overlaid with a cobalt alloy-based material by welding, and F2 coat is treatment of coating stainless steel with a material in which phosphorous is mixed in nickel. For example, when stainless steel is overlaid with Stellite, the Vickers hardness of the valve head 310a becomes 500 HV or higher, and when it is treated by F2 coat, the Vickers hardness of the valve head 310a becomes about 700 HV. Therefore, in view of a higher hardness, F2 coat is more preferable than Stellite overlaying.

As for the valve seat side (valve seat surface 200a3), the stainless steel is burnished, for instance. In the burnishing, a metal surface is crushed by a roller to plastically deform, thereby hardening its surface layer and finishing the surface to a mirror surface. In this embodiment, in order for the valve seat surface 200a3 to have the Vickers hardness of approximately not less than 200 nor more than 400 HV, the present inventors work the surface.

As described above, the present inventors apply the F2 coat to the valve head 310a so that its Vickers hardness becomes 500 HV or higher and applies the sheet burnishing to the valve seat surface 200a3 so that its Vickers hardness becomes approximately not less than 200 nor more than 400 HV, whereby the valve head 310a and the valve seat surface 200a3 are made different in hardness, and different surface hardening treatments are applied to the valve head 310a and the valve seat surface 200a3. Consequently, a smooth opening/closing operation of the valve element 310 is realized and galling and seizing are prevented.

On the other hand, when the valve seat surface 200a3 is too hard, a crystal structure of the material forming the valve seat surface 200a3 breaks, so that corrosion resistance lowers, and the material forming the valve seat exfoliates to scatter in the transport channel and mix in the film forming material in the transport channel, which will be a cause of contamination, and therefore, the Vickers hardness of the valve seat surface 200a3 is set to 400 HV or lower (preferably about not less than 200 nor more than 400 HV).

(Shapes of Valve Element and Valve Seat)

A portion, of the valve head 310a, abutting on the valve seat surface 200a3 is tapered, and a divergence θ of taper with respect to a line perpendicular to an end surface of the valve head 310a is 40° to 80°. The reason why the divergence θ of taper is limited to 40° to 80° is to improve a sealability. Consequently, the valve element 310 is more smoothly opened or closed and galling and seizing are prevented.

Incidentally, the portion, of the valve head 310a, abutting on the valve seat surface 200a3 may be arc-shaped. In this case, it preferably has a desired radius of curvature. Consequently, the valve element 310 is more smoothly opened or closed and galling and seizing are prevented.

Further, at the time of the assembly and finishing of the valve element 310, coaxiality alignment (rubbing) of the valve seat and the valve element is performed to eliminate a deviation between center axes of the valve element 310 and the valve seat surface 200a3, realizing an optimum finish state. As described above, galling and seizing are prevented by the special surface hardening treatments, which makes it possible to configure the regulating valve device 300 capable of stably maintaining operability, sealability, and heat resistance, by using the valve element and the valve seat which are both made of metal.

[Verification of Leakage State]

The present inventors verified the leakage state of the valve element 310 by using the regulating valve device 300 having the above-described structure. An experiment was conducted both for a state where the valve box 305 was set to 500° C. high temperature and for a state where the valve box 305 was set to room temperature. The divergence θ of taper of the abutting portion of the valve head 310a was set to 60°. The valve head 310a is made of SUS316 stainless steel having undergone the F2 coat surface treatment. The valve seat surface 200a3 is made of SUS316 stainless steel having undergone the burnishing. The Vickers hardness of the valve head 310a was 700 HV and the valve seat (valve seat surface 200a3) had a 400 HV Vickers hardness as a result of the sheet burnishing.

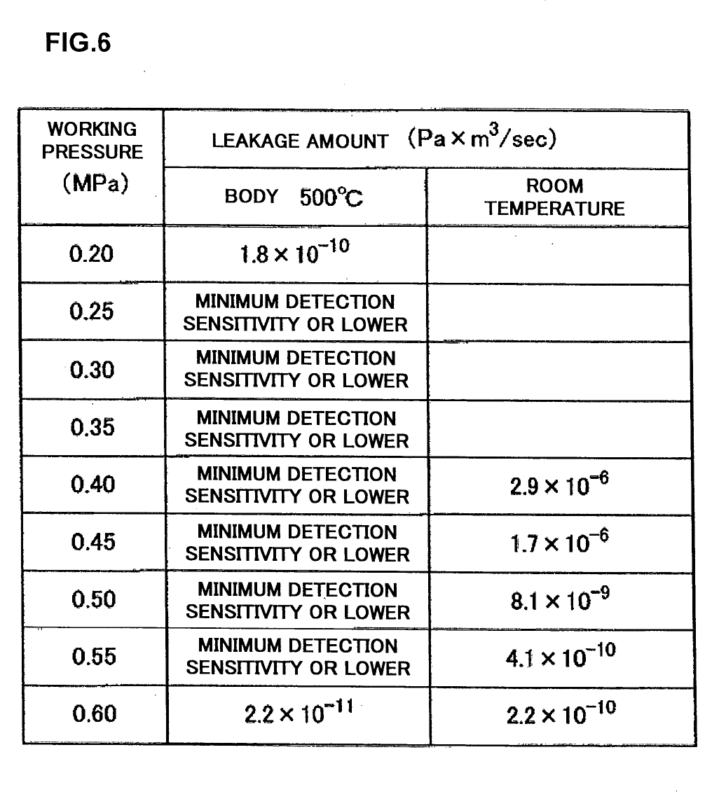

A working pressure (MPa), that is, a pressure when the pressurized air supplied from the first pipe 320d pressed the power transmitting member 320a, was varied, and when the temperature of the inside of the valve box 305 (body) was 500°, at all the working pressures (0.20 to 0.60: MPa) in the examination, a leakage amount was on the order of 10⁻¹¹ (Paxm³/sec) or lower, as shown in FIG. 6. Especially when the working pressure was 0.25 to 0.55 (MPa), the detection results of the leakage amount were the minimum detection sensitivity or lower. This indicates that it was not possible to detect the leakage amount because almost no leakage occurred.

On the other hand, when the temperature of the inside of the valve box was room temperature, the leakage amounts at the working pressures (0.50 to 0.60: MPa) were on the order of 10⁻⁹ (Paxm³/sec) or lower. From the above, it has been found out that even when the temperature of the inside of the valve box is room temperature, if the working pressure is 0.50 to 0.60

(MPa), the leakage amount on the order of 10⁻⁹ (Paxm³/sec) or lower can be attained, and in the high temperature state of about 500° C., the leakage amount can be further reduced. As compared with a conventional regulating valve device whose leakage amount is about 10⁻³ to 10⁻⁴ (Paxm³/sec), it is verified that in the regulating valve device 300 according to this embodiment, it is possible to repeat the opening/closing operation of the valve element 310 under the state with almost no leakage because the materials, shapes, and surface treatments of the valve element 310 and the valve seat are optimized.

Especially in the case of the organic film formation, the organic vapor deposition material passing through the transport channel 200a is used under a high-temperature, pressure-reduced environment. The reason why the organic vapor deposition material is used under the high temperature will be described. As shown in FIG. 2, the film forming materials (organic molecules) evaporated in the vapor deposition source units 100 pass through the transport channels 200a to be carried to the substrate G by the carrier gas Ar. During the transport, in consideration of the attachment coefficient, it is necessary to set the transport channels 200a to the high temperature state of 300° C. or higher in order to avoid the adhesion of the film forming materials on the inner walls of the transport channels 200a. Further, the reason why the organic vapor deposition material is used under the pressure-reduced state is that it is desired that the organic molecules are carried to the substrate G in a substantially contamination-free state, by setting the inside of the transport channels 200a to the pressure-reduced state.

This is why the vicinity of the valve element 310 is in the high-temperature, pressure-reduced state when the regulating valve device 300 according to this embodiment is used in the six-layer continuous film forming apparatus 10 for the organic film. However, as described above, in the opening/closing mechanism of the valve element 310 described above, almost no leakage occurs, and therefore, even when the transport channel side is under the vacuum environment, the atmosphere on the valve stem side does not flow into the transport channel side. As a result, it is possible to prevent the deterioration of the organic material passing through the transport channel 200a to realize good organic film formation.

In particular, the regulating valve device 300 according to this embodiment can maintain very high sealability even under the high temperature state of about 500° C. Further, since the valve element side and the valve seat side are both made of metal and the separation structure of the valve element is adopted, it is possible to realize a valve mechanism capable of preventing leakage with high accuracy.

Though a preferable embodiment of the present invention is described in the foregoing with reference to the attached drawings, it goes without saying that the present invention is not limited to such an example. It is obvious that those skilled in the art could think of various modification examples and corrected examples within the scope described in the claims, and these examples are naturally understood to belong to the technical scope of the present invention.

For example, the regulating valve device according to the present invention not only is used for opening/closing a transport channel provided in an organic EL apparatus but also is usable in a manufacturing apparatus requiring a valve opening/closing mechanism, such as a semiconductor manufacturing apparatus and a FPD apparatus. In particular, the regulating valve device according to the present invention is usable even in the high temperature state of about 500° C. and is also usable even in the vacuum state of about 10⁻¹ to 10² Pa.

Further, in the above-described embodiment, the air is supplied to the regulating valve device according to the present invention, but a working fluid supplied to the regulating valve device according to the present invention is not limited to this and may be gas such as inert gas or liquid such as oil.

Incidentally, a powdery (solid) organic material is usable as the film forming material of the organic EL apparatus according to the present invention. By using mainly liquid organic metal as the film forming material and decomposing the vaporized film forming material on a heated object to be processed, it is possible to use it for MOCVD (Metal Organic Chemical Vapor Deposition) that grows a thin film on an object to be processed.

### EXPLANATION OF REFERENCE NUMERALS AND SYMBOLS

10 six-layer continuous film forming apparatus
20 film forming unit
100 vapor deposition source unit
200 coupling pipe
200a transport channel
200a1 outward route
200a2 return route
300 regulating valve device
305 valve box
305a front member
305b bonnet
305c rear member
310 valve element
310a valve head
310b valve body
310c valve stem
315 sealing member
320 valve driving part
320a power transmitting member
320b first bellows
320c second bellows
320d first pipe
320e second pipe
330 purge port
335 metal gasket
400 blowout mechanism
500 partition plate
600 air supply source

1. A regulating valve device comprising:
a valve element in which a valve head and a valve body are coupled by a valve stem;
a power transmitting member coupled to the valve element via the valve stem and transmitting power to the valve element;
a valve box in which the valve element and the power transmitting member are slidably housed;
a first bellows having one end fixed to the power transmitting member and the other end fixed to the valve box to form a first space at a position on a side of the power transmitting member opposite the valve element;
a second bellows having one end fixed to the power transmitting member and the other end fixed to the valve box to form a second space at a position on a side of the power transmitting member closer to the valve element;
a first pipe communicating with the first space; and
a second pipe communicating with the second space,
wherein, according to a ratio of a working fluid supplied to the first space from the first pipe and a working fluid supplied to the second space from the second pipe, the power transmitting member transmits the power to the valve element via the valve stem to cause the valve head to open or close a transport channel formed in the valve box.

2. The regulating valve device according to claim 1, wherein the valve stem penetrates through a longitudinal center of the valve body and is inserted in a concave portion provided at a center of the valve head.

3. The regulating valve device according to claim 2, wherein an allowance is provided between the concave portion provided at the center of the valve head and the valve stem.

4. The regulating valve device according to claim 1, further comprising a third bellows having one end fixed to the valve head and the other end fixed to the valve body to shut off a space on the valve stem side and a space on the transport channel side from each other.

5. The regulating valve device according to claim 1, wherein a portion, of the valve head, abutting on the transport channel is tapered and a divergence θ of taper with respect to a line perpendicular to an end surface of the valve head is 40° to 80°.

6. The regulating valve device according to claim 1, wherein a portion, of the valve head, abutting on the transport channel is arc-shaped and has a structure having a desired radius of curvature.

7. The regulating valve device according to claim 1, wherein the valve head is metal overlaid with Stellite to have a 500 HV Vickers hardness or higher.

8. The regulating valve device according to claim 7, wherein the valve head is overlaid with a cobalt alloy-based material by welding.

9. The regulating valve device according to claim 1, wherein a valve seat surface of the transport channel abutting on the valve head is metal whose surface is worked by sheet burnishing to have Vickers hardness of approximately not less than 200 nor more than 400 HV.

10. The regulating valve device according to claim 1, being used for opening/closing a transport channel transporting an organic molecule for film formation on an object to be processed, up to a vicinity of the object to be processed.

11. The regulating valve device according to claim 10, being used under an environment where an inner part of the regulating valve device becomes 300° C. or higher.
